(19) United States
(12) Patent Application Publication
(10) Pub. No.: US 2008/0184219 A1
(43) Pub. Date: Jul. 31, 2008

(54) SOFTWARE UPDATING APPARATUS AND SOFTWARE UPDATING SYSTEM

(76) Inventor: Kunitoshi MATSUMOTO, Nasushiobara-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/015,168

(22) Filed: Jan. 16, 2008

(30) Foreign Application Priority Data
Jan. 30, 2007 (JP) 2007-020057

(51) Int. Cl. G06F 9/44

(52) U.S. Cl. 717/170; 717/168

(57) ABSTRACT

A software updating apparatus which is connected to a medical image diagnostic apparatus so that the software updating apparatus can freely communicate with the medical image diagnostic apparatus, and is used for updating control software for controlling an operation of the medical image diagnostic apparatus includes a first storage section which stores software having the same configuration as the configuration of the control software. An updating section updates the software stored in the first storage section. A testing section hypothetically tests whether or not the medical image diagnostic apparatus normally operates on the basis of the updated software.

### CROSS-REFERENCE TO RELATED APPLICATIONS

This application is based upon and claims the benefit of priority from prior Japanese Patent Application No. 2007-020057, filed Jan. 30, 2007, the entire contents of which are incorporated herein by reference.

### BACKGROUND OF THE INVENTION

1. Field of the Invention

The present invention relates to a software updating apparatus for updating control software for performing operation control of a medical image diagnostic apparatus and a software updating system provided with such a software updating apparatus.

2. Description of the Related Art

Heretofore, an update of software utilizing online facilities has been widely employed in, for example, updating of an operating system of a computer or the like. In recent years, an online update of control software for performing operation control of a medical image diagnostic apparatus such as an X-ray diagnostic apparatus or the like is now coming into common use (see, for example, Jpn. Pat. Appln. KOKAI Publication No. 2006-277574 and the like). In a general medical image diagnostic apparatus, an update of control software cannot be performed during use (for example, during a medical examination). Accordingly, in the conventional way, it is checked whether or not a medical image diagnostic apparatus which is an object of a software update is in use, and an update of control software is performed only if the medical image diagnostic apparatus is not in use.

In a medical image diagnostic apparatus, in particular, reliability of operation is required, and hence it is necessary to update the control software safely and reliably. Further, it is indispensable to test whether or not the medical image diagnostic apparatus operates normally after the update of the control software. However, this test is not completed in a short time, and finally requires an operation test to be performed by a service person. Further, while the test is performed, the medical image diagnostic apparatus cannot be used for the purpose of a medical examination, and hence this method is inefficient.

### BRIEF SUMMARY OF THE INVENTION

An object of the present invention is to provide a software updating apparatus and a software updating system capable of updating control software of a medical image diagnostic apparatus safely and efficiently.

According to a first aspect of the invention, there is provided a software updating apparatus which is connected to a medical image diagnostic apparatus so that the software updating apparatus freely communicates with the medical image diagnostic apparatus, and is used for updating control software for controlling an operation of the medical image diagnostic apparatus, the apparatus comprising: a first storage section which stores software having the same configuration as the configuration of the control software; an updating section which updates the software stored in the first storage section; and a testing section which hypothetically tests whether or not the medical image diagnostic apparatus normally operates on the basis of the updated software.

According to a second aspect of the invention, there is provided a software updating system comprising: a medical image diagnostic apparatus an operation of which is controlled by control software; a first terminal device in which update software for updating the control software is stored; a second terminal device including: (a) a storage section which stores software having the same configuration as the configuration of the control software; (b) an updating section which updates the software stored in the storage section by using the update software; and (c) a testing section which hypothetically tests whether or not the medical image diagnostic apparatus operates normally on the basis of the updated software.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a configuration of an example of a software updating system provided with a software updating apparatus according to a first embodiment of the present invention;

FIG. 2 is a view showing a maintenance terminal 100 in an enlarging manner;

FIG. 3 is a view showing an SP terminal 200 in an enlarging manner;

FIG. 4 is a view showing a software configuration of test execution software 203;

FIG. 5 is a view showing a medical image diagnostic apparatus 300 in an enlarging manner;

FIGS. 6A and 6B are views showing a workflow at the time of software update in the software updating system according to the first embodiment of the present invention;

FIGS. 7A and 7B are views showing a workflow at the time of software update in a modification example of the first embodiment;

FIGS. 8A and 8B are views showing a workflow at the time of restoration of a system environment in a software updating system according to a second embodiment of the present invention; and

FIG. 9 is a view showing a workflow at the time of a preliminary survey on a fault in a software updating system according to a third embodiment of the present invention.

### DETAILED DESCRIPTION OF THE INVENTION

Embodiments of the present invention will be described below with reference to the accompanying drawings.

### First Embodiment

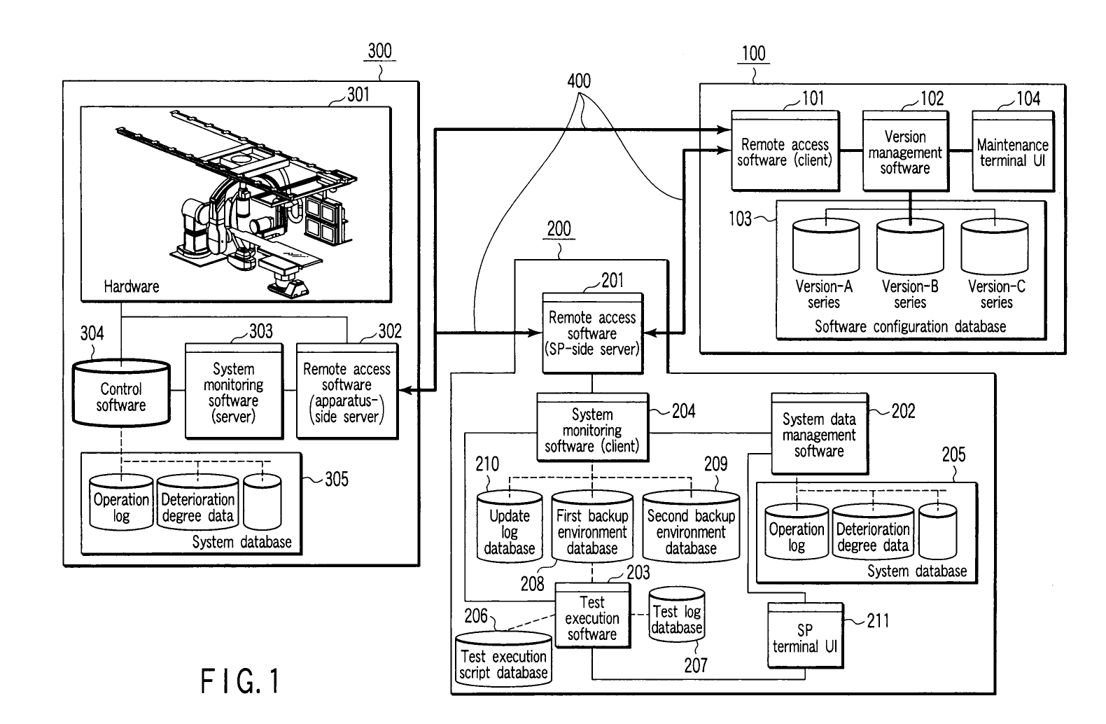

First, a first embodiment of the present invention will be described below. FIG. 1 is a view showing a configuration of an example of a software updating system provided with a software updating apparatus according to the first embodiment of the present invention. The software updating system shown in FIG. 1 includes a maintenance terminal 100, a service PC terminal (SP terminal) 200, and a medical image diagnostic apparatus 300. These are connected to each other so as to allow them to communicate with each other by data communication through a network 400. Here, in FIG. 1, an example in which one SP terminal 200 and one medical image diagnostic apparatus 300 are connected to the maintenance terminal 100 is shown. However, a plurality of SP terminals 200, and a plurality of medical image diagnostic apparatuses 300 are actually connected to the maintenance terminal 100. Further, the maintenance terminal 100 is installed in, for example, a facility (hereinafter referred to as a service center) in which maintenance service personnel for performing maintenance/inspection of the medical image diagnostic apparatus 300 are stationed. Further, the SP terminal 200 and the medical image diagnostic apparatus 300 are installed in, for example, a facility (hereinafter referred to as a site) such as a hospital in which the medical image diagnostic apparatus 300 is actually used.

The configuration shown in FIG. 1 will be described below in detail.

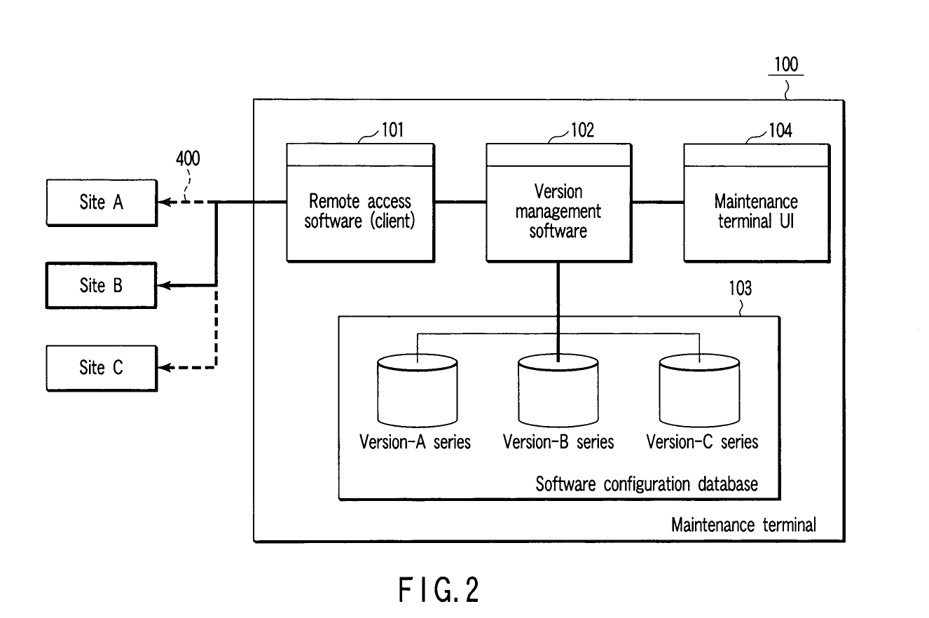

FIG. 2 is an enlarged view showing the maintenance terminal 100 of FIG. 1. The maintenance terminal 100 includes remote access software 101, version management software 102, a software configuration database 103, and a maintenance terminal user interface (UI) 104, and is a terminal apparatus such as a personal computer (PC).

The remote access software 101 is software by which the maintenance terminal 100 communicates with the SP terminal 200 and the medical image diagnostic apparatus 300 which are located in the site. The remote access software 101 is configured as software for performing communication on the basis of a standard protocol (for example, TCP/IP) used in ordinary Internet communication connection.

The version management software 102 is software for performing maintenance and management of the software configuration database 103.

Here, the remote access software 101 and the version management software 102 are respectively configured as software to be installed in, for example, the terminal apparatus constituting the maintenance terminal 100.

The software configuration database 103 includes updating software to be applied to the medical image diagnostic apparatus 300 as a database. This software configuration database 103 is constructed in a storage medium that can be read by the terminal apparatus of the maintenance terminal 100. Here, the updating software is to be prepared for each version of the medical image diagnostic apparatus 300. Incidentally, the version in this embodiment implies a version of control software (including both of hardware control and software control) for performing operation control of the medical image diagnostic apparatus 300. In FIG. 2, an example is shown in which three lines of databases are constructed so as to correspond to three sites. Needless to say, when the number of sites is increased, the number of pieces of updating software is also increased.

The maintenance terminal UI 104 is an interface necessary for an operator (in this case, a service person) to operate the maintenance terminal 100. For example, when the maintenance terminal 100 is constituted of a PC, the maintenance terminal UI 104 is constituted of a display such as a liquid crystal monitor and input devices and the like such as a mouse and a keyboard.

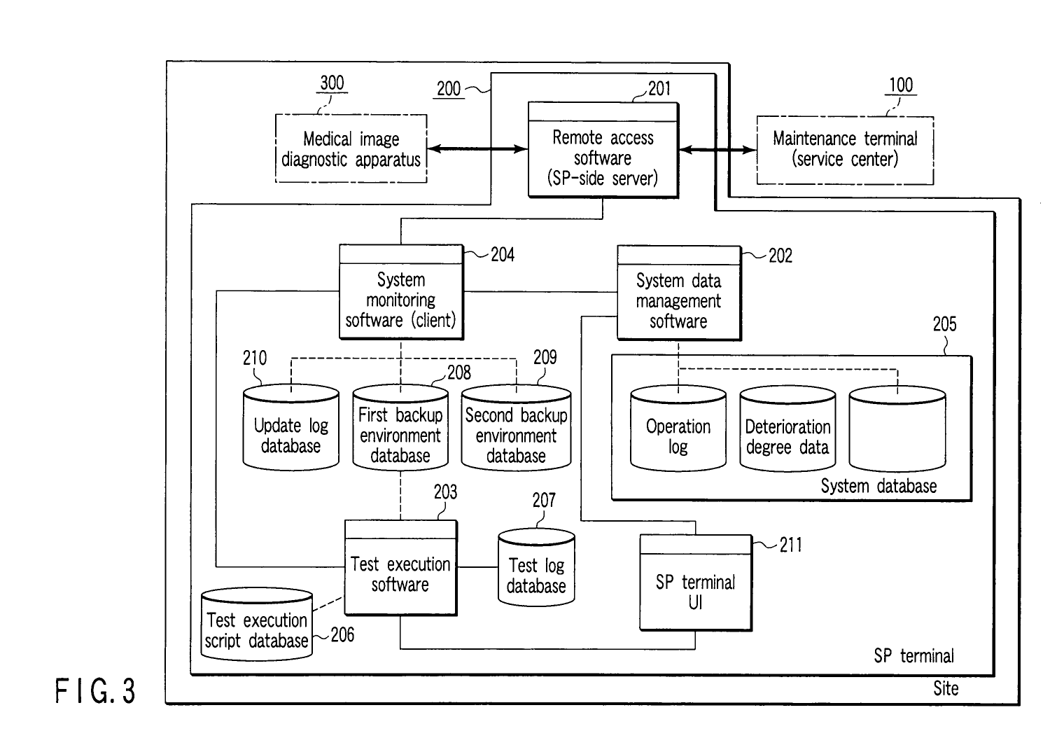

FIG. 3 is an enlarged view showing the SP terminal 200 of FIG. 1. The SP terminal 200 serving as the software updating apparatus includes remote access software 201, system data management software 202, test execution software 203, system monitoring software 204, a system database 205, a test execution script database 206, a test log database 207, a first backup environment database 208, a second backup environment database 209, an update log database 210, and an SP terminal user interface (UI) 211.

The remote access software 201 is software by which the SP terminal 200 communicates with the medical image diagnostic apparatus 300 in the site and the maintenance terminal 100 in the service center. This remote access software 201 is also configured as software for performing communication on the basis of a standard protocol (for example, TCP/IP) used in ordinary Internet communication connection like the remote access software of the maintenance terminal 100. Incidentally, the remote access software 201 becomes software on the server side when communication with the maintenance terminal 100 is performed.

The system data management software 202 is software for performing maintenance and management of the system database 205.

The test execution software 203 is software for automatically executing a test of control software stored in the first backup environment database 208 through a procedure conforming to a test execution script stored in the test execution script database 206. Further, the test execution software 203 also plays a role of a test stub. Hence, the SP terminal 200 can perform virtual hardware control assuming that the various types of hardware (for example, when the medical image diagnostic apparatus 300 is an X-ray diagnostic apparatus, an X-ray generator, a support, a bed, image processing hardware, and the like) of the medical image diagnostic apparatus 300 are connected thereto.

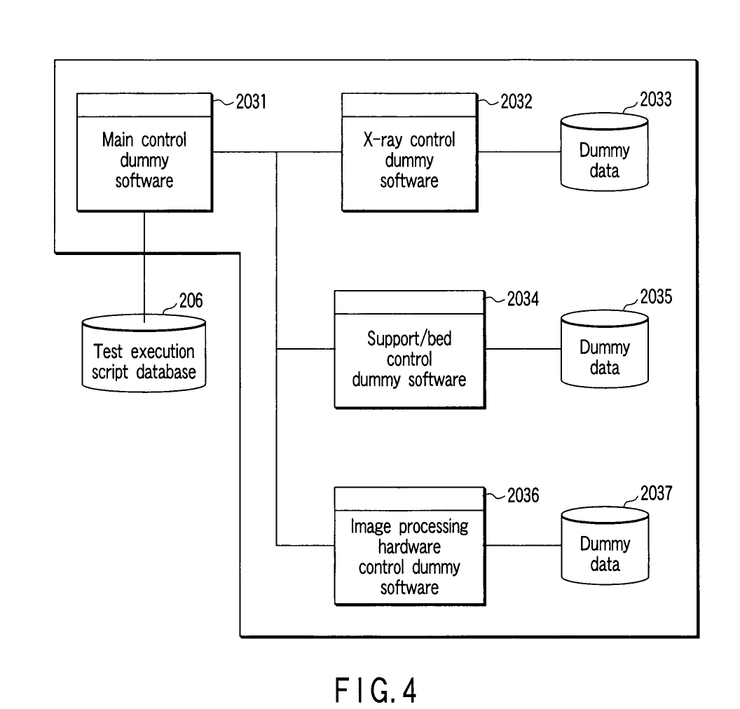

FIG. 4 is a view showing a software configuration of the test execution software 203. FIG. 4 shows an example in which the medical image diagnostic apparatus 300 is an X-ray diagnostic apparatus. Even when the medical image diagnostic apparatus 300 is a different type of medical image diagnostic apparatus, the basic configuration is that conforming to FIG. 4 except that contents of dummy data which is a control object of various types of control dummy software are different.

As shown in FIG. 4, the test execution software 203 includes main control dummy software 2031, X-ray control dummy software 2032, dummy data 2033, support/bed control dummy software 2034, dummy data 2035, image processing hardware control dummy software 2036, and dummy data 2037.

The main control dummy software 2031 is software for performing setting of each piece of dummy software in accordance with contents of control software stored in the first backup environment database 208, and executing a test in accordance with a test procedure and contents of test items stored in the test execution script database 206.

The X-ray control dummy software 2032 operates an X-ray generator hypothetically constructed on the condition conforming to the setting performed by the main control dummy software 2031. The dummy data 2033 is data for hypothetically realizing the operation of the X-ray generator used in the medical image diagnostic apparatus 300. When the X-ray control dummy software 2032 operates the X-ray generator hypothetically constructed by the dummy data 2033, the dummy data 2033 performs virtual X-ray irradiation. Further, a result (a level of the X-ray and the like obtained at the time of performing virtual X-ray irradiation) obtained by performing the virtual X-ray irradiation is returned to the main control dummy software 2031 through the X-ray control dummy software 2032. The main control dummy software 2031 determines whether or not the test is successful in accordance with a success/failure determination criterion of a test stored in the test execution script database 206, records a determination result in the test log database 207, and returns the result to the maintenance terminal 100.

The support/bed control dummy software 2034 operates the support and the bed hypothetically constructed on the condition conforming to the setting performed by the main control dummy software 2031. The dummy data 2035 is data for hypothetically realizing operations of the support and the bed used in the medical image diagnostic apparatus 300. When the support/bed control dummy software 2034 operates the support or the bed hypothetically constructed by the dummy data 2035, the dummy data 2035 hypothetically operates as the support or the bed. Further, a result (an amount of movement of the support or the bed) obtained by the dummy data 2035 by hypothetically operating as the support or the bed is returned to the main control dummy software 2031 through the support/bed control dummy software 2034. The main control dummy software 2031 determines whether or not the test is successful in accordance with the success/failure determination criterion of a test stored in the test execution script database 206, records a determination result in the test log database 207, and returns the result to the maintenance terminal 100.

The image processing hardware control dummy software 2036 performs an operation test of image processing hardware hypothetically constructed in accordance with the setting performed by the main control dummy software 2031. The dummy data 2037 is data for hypothetically realizing an operation of the image processing hardware used in the medical image diagnostic apparatus 300. When the image processing hardware control dummy software 2036 operates the image processing hardware hypothetically constructed by the dummy data 2037, the dummy data 2037 performs image processing assuming that for example, a predetermined X-ray signal for testing is input. Further, the dummy data 2037 returns a result of the image processing to the main control dummy software 2031 through the image processing hardware control dummy software 2036. The main control dummy software 2031 determines whether or not the test is successful in accordance with the success/failure determination criterion of a test stored in the test execution script database 206, records a result of the determination in the test log database 207, and returns the result to the maintenance terminal 100.

The system monitoring software 204 is software for making inquiries at the medical image diagnostic apparatus 300 in order to monitor the status of use of the medical image diagnostic apparatus 300, and performing maintenance/management of the first backup environment database 208 and the second backup environment database 209 of the SP terminal 200. System monitoring software is installed also in the medical image diagnostic apparatus 300, and the system monitoring software on the SP terminal 200 side is on the client side. Further, the system monitoring software 204 performs management of version information of the control software of the medical image diagnostic apparatus 300.

Here, the remote access software 201, system data management software 202, test execution software 203, and system monitoring software 204 are configured as software to be installed in, for example, the terminal apparatus constituting the SP terminal 200.

The system database 205 has, as a database, various data items relating to the operation of the medical image diagnostic apparatus 300 such as an operation log for recording an operational state of the medical image diagnostic apparatus 300, deterioration degree data of the medical image diagnostic apparatus 300, and the like. These data items are updated each time, for example, a new examination is performed on the medical image diagnostic apparatus 300. The update is performed by the system data management software 202.

The test execution script database 206 has data in which, for example, test items, order of tests, test success/failure determination criteria, and the like are described in detail as various data items necessary for the test to be executed by the test execution software 203. Here, these data items which differ depending on the contents of an update performed by the maintenance terminal 100 and each configuration (each version) of the medical image diagnostic apparatus 300 are stored.

The test log database 207 has results (test log) of tests executed by the test execution software 203 as a database. The test log is made each time a test is executed.

Each of the first backup environment database 208 and the second backup environment database 209 has the same software configuration (including data) as the medical image diagnostic apparatus 300 as a database. The contents of each of the first backup environment database 208 and the second backup environment database 209 are updated in accordance with the control of the system monitoring software 204 each time a new examination is performed on the medical image diagnostic apparatus 300 or each time the control software of the medical image diagnostic apparatus 300 is updated by the maintenance terminal 100.

The update log database 210 has records associated with the update of software for the medical image diagnostic apparatus 300 as an update log.

The SP terminal UI 211 is an interface necessary for the operator (in this case, a service person) to operate the SP terminal 200. For example, when the SP terminal is constituted of a PC, the SP terminal UI 211 is constituted of a display such as a liquid crystal monitor and input devices and the like such as a mouse and a keyboard. Further, a printer may be provided so that the above-mentioned various logs can be printed on paper sheets.

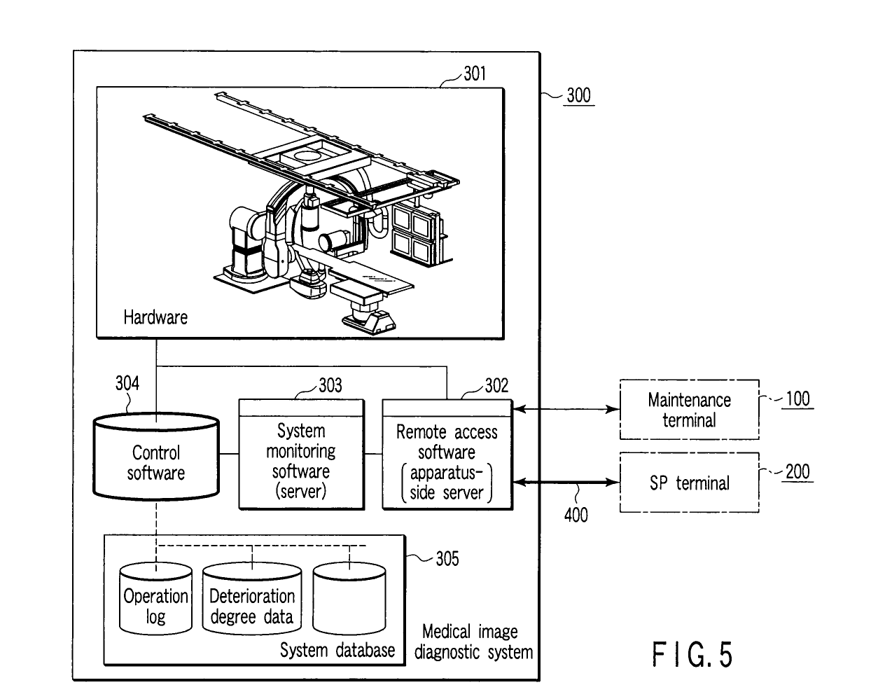

FIG. 5 is a view showing a medical image diagnostic apparatus 300 in an enlarging manner. The medical image diagnostic apparatus 300 is constituted of hardware 301, remote access software 302, system monitoring software 303, control software 304, and a system database 305.

The hardware 301 is a generic term of a hardware system constituting the medical image diagnostic apparatus 300. For example, when the medical image diagnostic apparatus 300 is an X-ray diagnostic apparatus, an X-ray generator, mechanical drive sections such as a support and a bed, image processing hardware, and the like are included therein.

The remote access software 302 is software by which the medical image diagnostic apparatus 300 communicates with the SP terminal 200 in the site and the maintenance terminal 100 in the service center. The remote access software 302 is also configured as software capable of performing communication on the basis of a standard protocol (for example, TCP/IP) used in ordinary Internet communication connection like the remote access software of the maintenance terminal 100. Incidentally, the remote access software 302 becomes software on the server side when communication with the maintenance terminal 100 is performed.

The system monitoring software 303 is software for monitoring the status of use of the medical image diagnostic apparatus 300 and the operational state of the other system constituting the medical image diagnostic apparatus 300.

The control software 304 is a generic term of a software group which is an object of the software update performed by the maintenance terminal 100, and used for performing various types of control of the medical image diagnostic apparatus 300. The control software 304 includes software (firmware) for performing operation control of the hardware 301, software for performing display control of a graphical user interface (GUI) for displaying information on the display such as a liquid crystal monitor, and the like, and various control data items necessary for the operation of these pieces of software.

The system database 305 has an operation log for recording the operational state of medical image diagnostic apparatus 300, and various data items relating to the operation of the medical image diagnostic apparatus 300 such as deterioration degree data of the medical image diagnostic apparatus 300, and the like as a database. These data items are updated in accordance with the control of the control software 304 each time, for example, a new examination is performed on the medical image diagnostic apparatus 300.

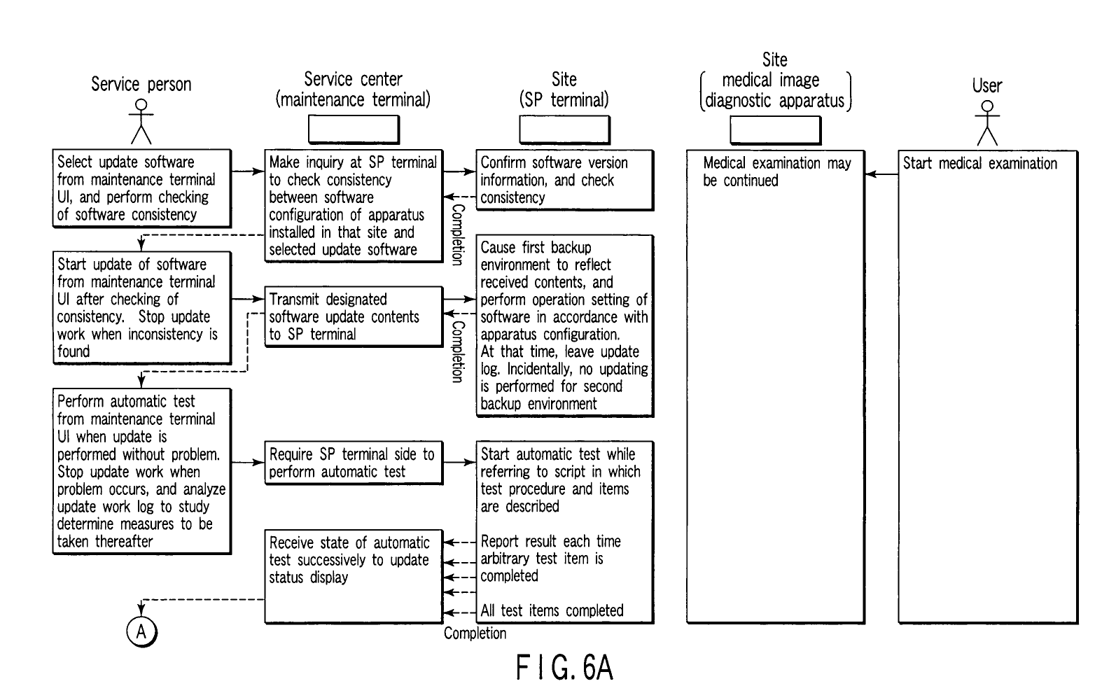

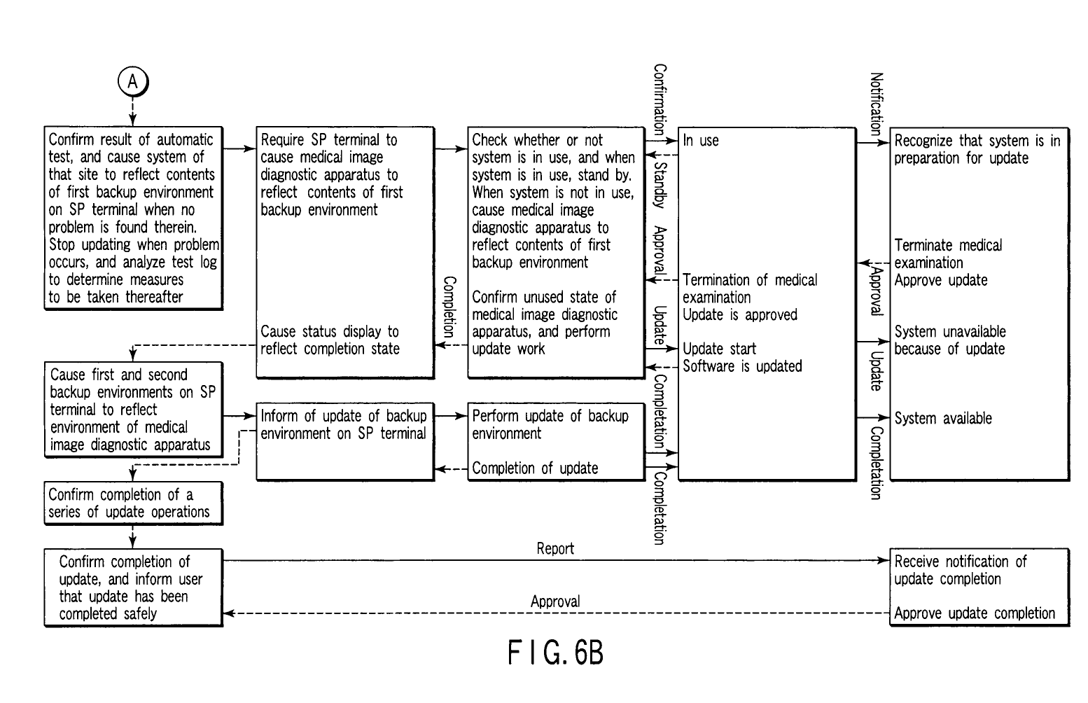

A function of the first embodiment will be described below. FIGS. 6A and 6B are views showing a workflow at the time of software update in the software updating system according to the first embodiment of the present invention.

When an update is performed, first, the service person stationed in the service center selects the update software by operating the operation devices of the maintenance terminal UI 104. In this case, it is assumed that for example, a version-B series for the site B is selected. After selecting the update software, the service person instructs the maintenance terminal 100 to check the consistency of the selected update software. In response to this instruction, the maintenance terminal 100 makes an inquiry at the SP terminal 200 so as to check the consistency between the software configuration of the medical image diagnostic apparatus 300 installed in the site B and the selected update software.

Upon receiving the inquiry from the maintenance terminal 100, the SP terminal 200 starts the system monitoring software 204 to confirm the version information of the medical image diagnostic apparatus 300 from the data of the software configuration having the same contents as those of the medical image diagnostic apparatus 300 stored in the first backup environment database 208, and to check the consistency, and returns the result to the maintenance terminal 100. The maintenance terminal 100 outputs the result of the consistency checking supplied from the SP terminal 200 by displaying the result on the display of the maintenance terminal UI 104 so that the service person can confirm the result. These items of processing are those performed only between the maintenance terminal 100 and the SP terminal 200, and hence users (doctors) in the site B can perform a medical examination and the like by using the medical image diagnostic apparatus 300.

Then, the service person confirms the result of the consistency checking. Further, when no problem is found in the consistency checking result, the service person operates the operation devices of the maintenance terminal UI 104 to start update of the control software. On the other hand, when any problem is found in the consistency checking result, the update of the control software is stopped at the point in time.

When an instruction to start update of the control software is issued through the operation devices of the maintenance terminal UI 104, the maintenance terminal 100 transmits the update software (here the version-B series) selected by the service person to the SP terminal 200. Upon receipt of the update software, the SP terminal 200 causes the data of the software configuration having the same contents as those of the medical image diagnostic apparatus 300 stored in the first backup environment database 208 to reflect the contents of the update software. Further, the SP terminal 200 performs setting of each piece of control dummy software in the test execution software 203 in accordance with the contents of the update. Further, the SP terminal 200 records the result of the update operations in the update log database 210 as an update log. Further, after these items of processing are completed, the SP terminal 200 informs the maintenance terminal 100 of the fact that the update is completed. Upon receipt of the notification of the update completion from the SP terminal 200, the maintenance terminal 100 informs the service person of the completion of the update by displaying a message expressing that the update is completed on, for example, the display of the maintenance terminal UI 104.

In this update processing, no update is performed for the second backup environment database 209. This is because when any fault is found in the update applied to the software configuration data of the first backup environment database 208, the software configuration data of the first backup environment database 208 is restored to the original state by using the software configuration data of the second backup environment database 209.

Then, the service person confirms the update result. When no problem is found in the update result, the service person operates the operation devices of the maintenance terminal UI 104 to start an automatic test. On the other hand, when any problem is found in the update result, the service person stops the update, obtains the update log from the SP terminal 200, and analyzes the obtained update log so as to determine the measures to be taken thereafter.

When the instruction to start the automatic test is issued through the maintenance terminal UI 104, the maintenance terminal 100 requires the SP terminal 200 to perform the automatic test. Upon receipt of this requirement, the SP terminal 200 starts the test execution software 203 to control each piece of the control dummy software described above in accordance with the test script stored in the test execution script database 206, thereby performing the test. Further, each time a test item is completed, a test result is returned to the maintenance terminal 100. Furthermore, when all the test items are completed, the maintenance terminal 100 is informed of the fact. The maintenance terminal 100 updates the display of the display of the maintenance terminal UI 104 each time the maintenance terminal 100 receives a test result from the SP terminal 200, and outputs the test result so that the service person can confirm the test result.

Then, the service person confirms the test results. When no problem is found in the test results, the service person operates the operation devices of the maintenance terminal UI 104 to send an instruction to cause the control software 304 of the medical image diagnostic apparatus 300 to actually reflect the update contents applied to the first backup environment database 208. On the other hand, if any problem is found in the update result, the update is stopped, the test log is acquired from the SP terminal 200, the acquired test log is analyzed, thereby determining the measures to be taken thereafter.

When an instruction to update the control software 304 of the medical image diagnostic apparatus 300 is issued through the operation devices of the maintenance terminal UI 104, the maintenance terminal 100 informs the SP terminal 200 of the update request of the control software 304 of the medical image diagnostic apparatus 300. Upon receipt of the update request, the SP terminal 200 starts the system monitoring software 204, and makes an inquiry about whether or not the system is in use at the medical image diagnostic apparatus 300 so as to check whether or not the medical image diagnostic apparatus 300 is in use. Upon receipt of the inquiry, the medical image diagnostic apparatus 300 starts the system monitoring software and determines whether or not the system of the medical image diagnostic apparatus 300 is currently used in a medical examination or an additional process. When the system is in use, the medical image diagnostic apparatus 300 informs the SP terminal 200 of the fact. When receives a notification indicating that the system is in use from the medical image diagnostic apparatus 300, the SP terminal 200 waits for a notification of an update approval from the medical image diagnostic apparatus 300.

Further, the medical image diagnostic apparatus 300 informs the user that the update preparation for the control software 304 is completed in the SP terminal 200. The user can acknowledge that the update preparation is completed by seeing the notification.

After the examination is completed, the user issues an approval of the update of the control software by means of operation devices (not shown) of the medical image diagnostic apparatus 300. Upon receipt of the approval, the medical image diagnostic apparatus 300 informs the SP terminal 200 that the update of the control software 304 is approved. Upon receipt of the approval, the SP terminal 200 causes the control software 304 of the medical image diagnostic apparatus 300 to reflect the update applied to the first backup environment database 208. For example, the control software 304 of the medical image diagnostic apparatus 300 is overwritten with the contents stored in the first backup environment database 208. Incidentally, during the update, the medical image diagnostic apparatus 300 cannot be used, and, for example, even when the user operates the medical image diagnostic apparatus 300, the operation is made ineffective.

In this case, in the example shown in FIGS. 6A and 6B, if the update approval is not received from the medical image diagnostic apparatus 300, the standby state is maintained. However, when the user is not near the medical image diagnostic apparatus 300, there may be a case where update approval cannot be sent even when the apparatus 300 is not in use. Hence, update may be performed when a predetermined time, for example, about ten minutes has elapsed after inquiring of the medical image diagnostic apparatus 300 whether or not the system is in use.

After the update is completed, the SP terminal 200 informs the maintenance terminal 100 and the medical image diagnostic apparatus 300 that the update is completed. Upon receipt of the update completion notification, the medical image diagnostic apparatus 300 informs the user that the medical image diagnostic apparatus 300 has become available. As a result, the user can recognize that the medical image diagnostic apparatus 300 has become available.

On the other hand, in response to the update completion notification, the maintenance terminal 100 informs the service person that the update is completed. Upon confirmation of the update completion, the service person sends an instruction to cause the contents of each of the first and the second backup environment databases of the SP terminal 200 to reflect the same update as that applied to the control software 304 of the medical image diagnostic apparatus 300 to the SP terminal 200 through the operation devices of the maintenance terminal UI 104. Upon receipt of this instruction, the SP terminal 200 copies the contents of the first backup environment database 208 to the second backup environment database 209. As a result of this, the medical image diagnostic apparatus 300 and the SP terminal 200 have control software items equivalent to each other at all times.

After causing the first and second backup environment databases of the SP terminal 200 to reflect the update contents of the medical image diagnostic apparatus 300, the SP terminal 200 informs the maintenance terminal 100 that the update is completed. Upon receipt of this notification, the maintenance terminal 100 informs the service person of the update completion by displaying a message expressing that the update is completed on, for example, the display of the maintenance terminal UI 104.

Then, after confirming the completion of the update, the service person informs the user that the update has safely been completed by, for example, e-mail or the like. The user receives the update completion notification from the service person, confirms that the update has been completed, approves the fact, and returns the approval reply to the service person. As a result, a series of update operations is completed.

As described above, according to the first embodiment, when the control software of the medical image diagnostic apparatus is automatically updated, it is tested whether or not the updated control software operates normally by using hardware hypothetically provided in the SP terminal, and the actual update is thereafter performed. Accordingly, the time for which the medical image diagnostic apparatus is occupied by the test can be minimized.

Further, when a fault is found in the test performed by using the SP terminal, the update is stopped. Accordingly, the medical image diagnostic apparatus is not inappropriately updated, and can be updated safely. Further, the two types of backup environments, i.e., the first backup environment database 208 and the second backup environment database 209 are provided on the SP terminal, and hence even when a fault occurs in the test on the SP terminal, the first backup environment database 208 that has been subjected to the update can be restored to the original state.

In the workflow of FIGS. 6A and 6B, the software consistency checking result, test result, and update result are confirmed by the service person, and the update is shifted to the next processing after the execution instruction of the next processing is issued. However, the update may be fully automated by imparting a function of comparing the software consistency checking result, test result, and update result with predetermined criteria to, for example, the maintenance terminal 100, and by automatically executing the next processing when these results meet the predetermined criteria.

### Modification Example

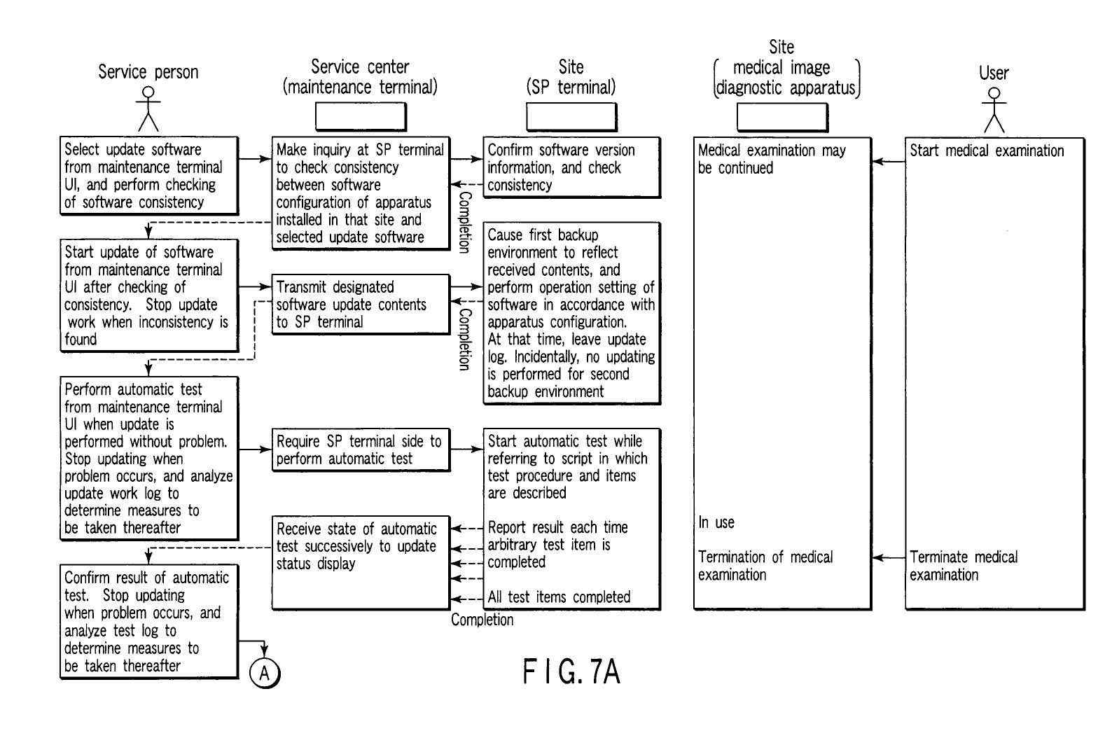

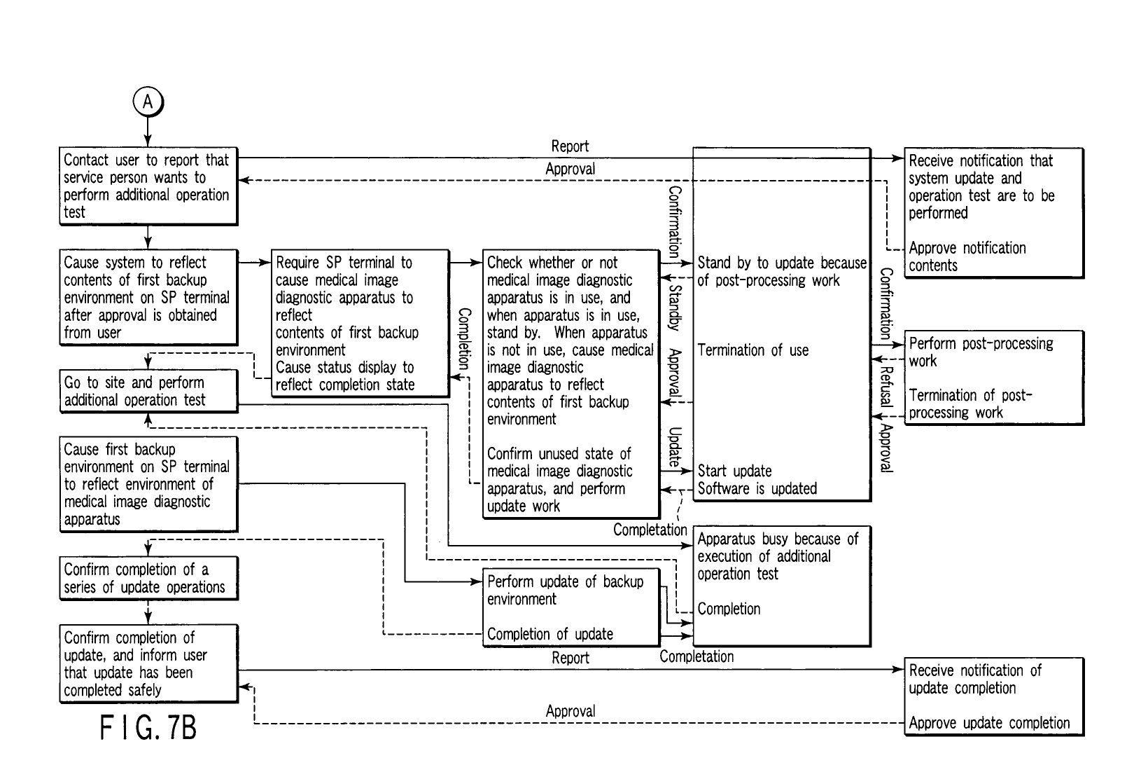

Next, a modification example of the first embodiment will be described below. In the first embodiment described above, the description is given assuming that all the tests are performed on the SP terminal. However, there may be test items that cannot be fully performed by the automatic test depending on the contents of the update. For example, when the medical image diagnostic apparatus is an X-ray diagnostic apparatus, even if X-ray irradiation is performed at an appropriate level on the automatic test, it is still desirable that it be confirmed on the actual apparatus whether or not the X-ray irradiation is performed at the appropriate level. The modification example to be described with reference to FIGS. 7A and 7B is of the case where the test items include those test items that cannot be fully performed by the automatic test. Incidentally, the configuration is the same as FIG. 1, and the workflow is partly identical with FIGS. 6A and 6B. Therefore, a description of parts identical with those described previously is omitted. The part of the workflow from selection of the update software by the service person to confirmation of the automatic test by the service person is identical with that in FIGS. 6A and 6B.

In FIGS. 7A and 7B, after confirming the result of the automatic test, if no problem is found in the test result, the service person informs the user by, for example, e-mail, that the service person wants to perform an additional operation test. When this requirement is approved by the user, the service person operates the operation devices of the maintenance terminal UI 104 to issue an instruction to cause the control software 304 of the medical image diagnostic apparatus 300 to actually reflect the update contents applied to the first backup environment database 208. Upon receipt of this instruction, the maintenance terminal 100 informs the SP terminal 200 of the update request of the control software 304 of the medical image diagnostic apparatus 300. Upon receipt of this notification, the SP terminal 200 starts the system monitoring software 204, and inquires of the medical image diagnostic apparatus 300 whether or not the system is in use in order to check whether or not the medical image diagnostic apparatus 300 is in use. Upon receipt of the inquiry, the medical image diagnostic apparatus 300 starts the system monitoring software to determine whether or not the system of the medical image diagnostic apparatus 300 is currently used in an examination or an additional process. When the system is in use, the medical image diagnostic apparatus 300 informs the SP terminal 200 of the fact. When receives a notification indicating that the system is in use from the medical image diagnostic apparatus 300, the SP terminal 200 waits for reception of an update approval from the medical image diagnostic apparatus 300.

Here, in the example of FIGS. 7A and 7B, an example in which although the test is completed, the medical image diagnostic apparatus 300 is now in use for an additional process is shown.

After the additional process is completed, the user issues an instruction indicating that the update of the control software 304 is approved through the operation devices (not shown) of the medical image diagnostic apparatus 300. Upon receipt of this instruction, the medical image diagnostic apparatus 300 informs the SP terminal 200 that the update of the medical image diagnostic apparatus 300 is approved. Upon receipt of this notification, the SP terminal 200 causes the control software 304 of the medical image diagnostic apparatus 300 to reflect the update applied to the first backup environment database 208. For example, the control software 304 of the medical image diagnostic apparatus 300 is overwritten with the contents stored in the first backup environment database 208. Incidentally, as in the first embodiment, during the update, the medical image diagnostic apparatus 300 cannot be used, and, for example, even when the user operates the medical image diagnostic apparatus 300, the operation is made ineffective.

After the update is completed, the SP terminal 200 informs the maintenance terminal 100 that the update is completed. Upon receipt of the update completion notification, the maintenance terminal 100 informs the service person that the update is completed. Upon confirmation of the update completion, the service person goes to the site (site B) where the medical image diagnostic apparatus 300 which is the object of the update is installed, and performs the additional operation test. During the additional operation test, the medical image diagnostic apparatus 300 cannot be used.

After the additional operation test is completed, when no problem is found in the test result, the service person returns to the service center, and operates (or another service person may operate) the operation devices of the maintenance terminal UI 104 to send an instruction to cause the contents of each of the first and the second backup environment databases of the SP terminal 200 to reflect the same update as that applied to the control software 304 of the medical image diagnostic apparatus 300. Upon receipt of this instruction, the SP terminal 200 copies the contents of the first backup environment database 208 to the second backup environment database 209. As a result of this, the medical image diagnostic apparatus 300 and the SP terminal 200 have control software items equivalent to each other at all times.

After causing the first and second backup environment databases of the SP terminal 200 to reflect the update contents of the medical image diagnostic apparatus 300, the SP terminal 200 informs the maintenance terminal 100 that the update is completed. Upon receipt of this notification, the maintenance terminal 100 informs the service person of the update completion by displaying a message expressing that the update is completed on, for example, the display of the maintenance terminal UI 104.

Then, after confirming the completion of the update, the service person informs the user that the update has safely been completed by, for example, e-mail or the like. The user receives the update completion notification from the service person, and confirms that the update has been completed. After the confirmation, the user approves the update completion, and returns the approval reply to the service person. As a result, a series of update operations is completed.

As described above, by following the workflow shown in FIGS. 7A and 7B described above, it is possible to complete items that can be performed by the automatic test in advance. As a result of this, it is possible to perform the test with the minimum downtime.

### Second Embodiment

Next, a second embodiment of the present invention will be described below. In the second embodiment, when any failure (corruption of control data or the like) occurs in the control software 304 of a medical image diagnostic apparatus 300, the control software is restored to the original state. Incidentally, the configuration is the same as that shown in FIG. 1, and hence the description thereof is omitted.

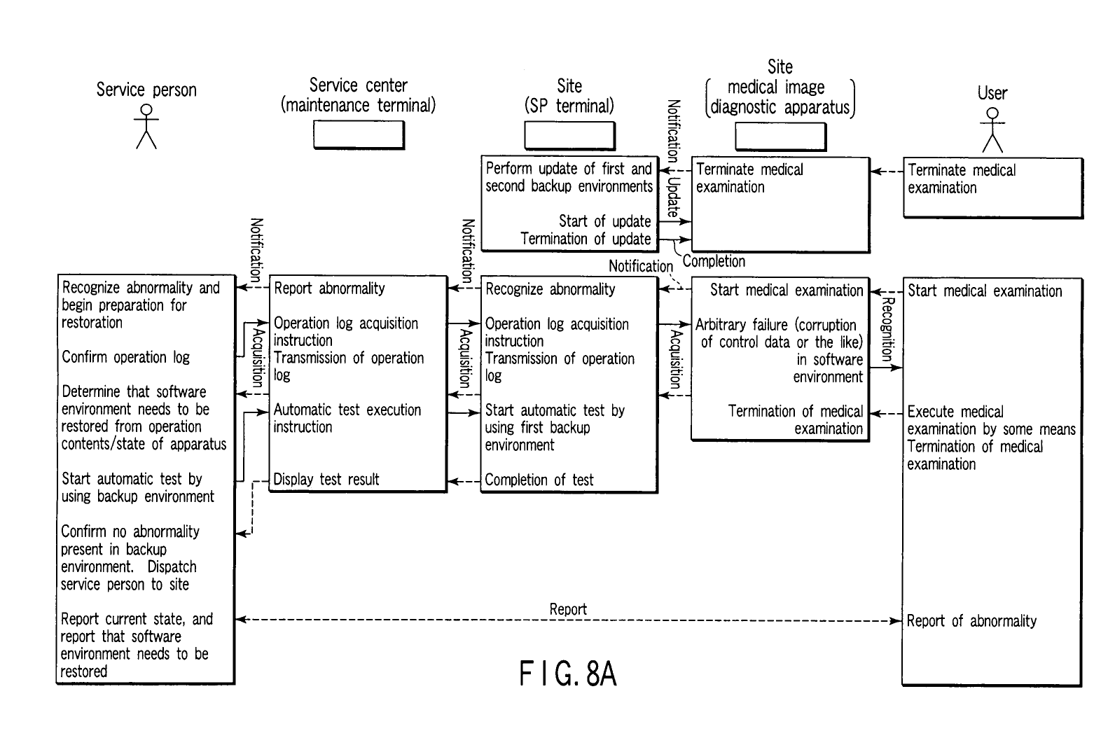

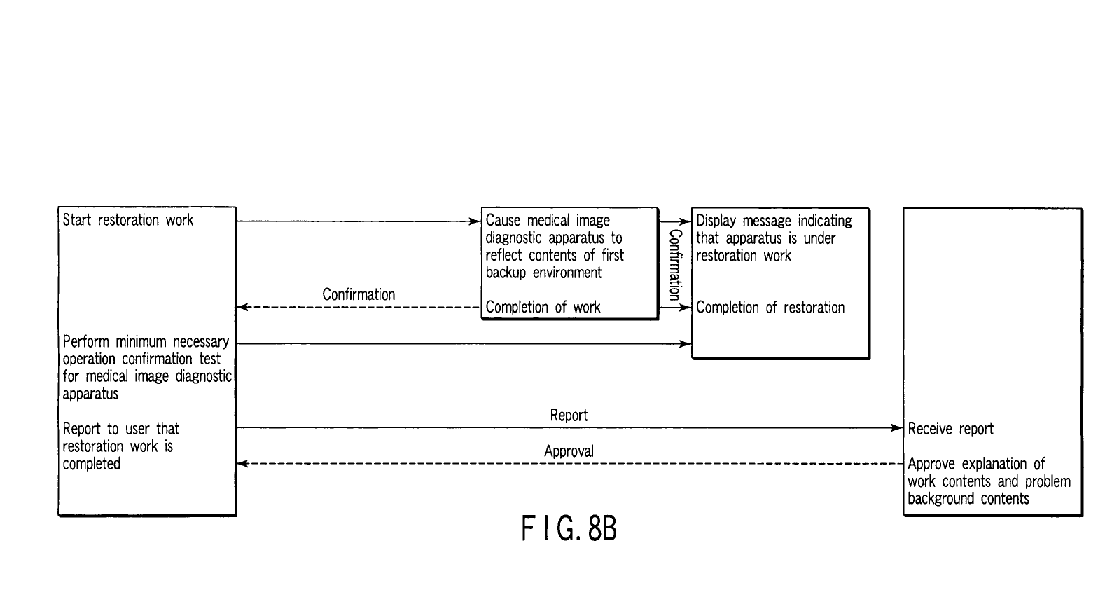

FIGS. 8A and 8B are views showing a workflow at the time of restoration of system environment in a software updating system according to the second embodiment.

First, following the workflow described in the first embodiment, contents of each of first and second backup environment of an SP terminal 200 are equivalent to contents of control software 304 of the medical image diagnostic apparatus 300.

Thereafter, if a failure occurs in the control software 304 while a user uses the medical image diagnostic apparatus 300 for a medical examination or the like, the medical image diagnostic apparatus 300 informs the user and the SP terminal 200 of the fact. Upon receipt of the notification, the SP terminal 200 recognizes the abnormality of the medical image diagnostic apparatus 300. Further, the SP terminal 200 informs a maintenance terminal 100 that there is an abnormality in the medical image diagnostic apparatus 300. The maintenance terminal 100 provides an output so that the service person can confirm that there is an abnormality in the medical image diagnostic apparatus 300 by displaying the fact on a display of a maintenance terminal UI 104. By confirming the display contents, the service person recognizes that an abnormality has occurred in the medical image diagnostic apparatus 300 of the site. Further, the service person operates operation devices of the maintenance terminal UI 104 to require acquisition of an operation log from the medical image diagnostic apparatus 300. The maintenance terminal 100 transmits an instruction to acquire the operation log to the SP terminal 200. Upon receipt of the instruction, the SP terminal 200 transmits an instruction to acquire the operation log stored in a system database 305 of the medical image diagnostic apparatus 300 to the medical image diagnostic apparatus 300. Upon receipt of the operation log acquisition instruction, the medical image diagnostic apparatus 300 acquires the operation log. After the acquisition of the operation log, the medical image diagnostic apparatus 300 transmits the acquired operation log to the maintenance terminal 100 through the SP terminal 200. The maintenance terminal 100 provides an output so that the service person can confirm the operation log by displaying the received log on the display of the maintenance terminal UI 104.

The service person confirms the operation log. Further, the service person determines whether or not restoration of the control software 304 of the medical image diagnostic apparatus 300 is necessary. When the restoration is necessary, in order to first perform an automatic test on a backup environment constructed in the SP terminal 200, the service person operates the operation devices of the maintenance terminal UI 104 to start the automatic test.

When an automatic test start instruction is issued through the operation devices of the maintenance terminal UI 104, the maintenance terminal 100 requires the SP terminal 200 to perform the automatic test. At this time, a test script for performing an overall operation test is also transmitted from the maintenance terminal 100 to the SP terminal 200. Incidentally, the test script for the overall operation test may be stored in advance in a test execution script database 206 of the SP terminal 200.

Upon receipt of the automatic test start instruction from the maintenance terminal 100, the SP terminal 200 starts test execution software 203 to control each piece of control dummy software and perform a test. Further, the SP terminal 200 returns a test result to the maintenance terminal 100 each time a test item is completed. Further, when all the test items are completed, the SP terminal 200 informs the maintenance terminal 100 of the completion of all the test items. The maintenance terminal 100 updates the display of the display of the maintenance terminal UI 104, and outputs the test result so that the service person can confirm the test result each time it receives a test result from the SP terminal 200.

Then, the service person confirms the test result, and if no problem is found in the test result, the service person determines that there is no abnormality in the update applied to the backup environment. Thereafter, the service person goes to a site where an abnormality has occurred, reports that the control software 304 of the medical image diagnostic apparatus 300 needs to be restored to the user, and starts restoration of the control software 304. First, the service person causes the control software 304 of the medical image diagnostic apparatus 300 to reflect the contents of the first backup environment database 208 for which it has been determined in the automatic test that no problem is found. The medical image diagnostic apparatus 300 cannot be used during the update, and, for example, even when the user operates the medical image diagnostic apparatus 300, the operation is made ineffective.

After the restoration is completed, the service person performs the minimum necessary operation confirmation test, and if no problem is found in the test result, the service person reports that the restoration work has been completed to the user. When the user approves the contents of the report, a series of the restoration operations is completed.

As described above, according to the second embodiment, by storing data (software) having the same configuration as that of the control software 304 of the medical image diagnostic apparatus 300 in the first backup environment database 208, the restoration work of the control software 304 can be performed in a relatively simple manner.

There may be a case where the control software 304 must be restored to the same software environment as that at the time before the update has been applied to the first and second backup databases with respect to the restoration contents. The above case is, for example, a case where a problem is caused when the operation test of the restoration work is performed, or the like. Assuming such a case, a new database for storing the software environment at the time before application of the update may be constructed separately from the first and second backup environment databases. That is, control software of a version older than the latest version by one version is stored in this database at all times, whereby it becomes possible to return the control software 304 of the medical image diagnostic apparatus 300 to that of the previous version.

### Third Embodiment

Next, a third embodiment of the present invention will be described below. In the third embodiment, in a case where a failure (corruption of control data or the like) occurs in the control software 304 of a medical image diagnostic apparatus 300, and at the same time, in a case where the control software cannot be immediately restored, only the test is performed in advance. Incidentally, the terms “a case where the control software cannot be immediately restored” include, for example, a case where the medical image diagnostic apparatus 300 is used for an examination of a long period of time. The configuration is the same as that shown in FIG. 1, and hence a description thereof is omitted.

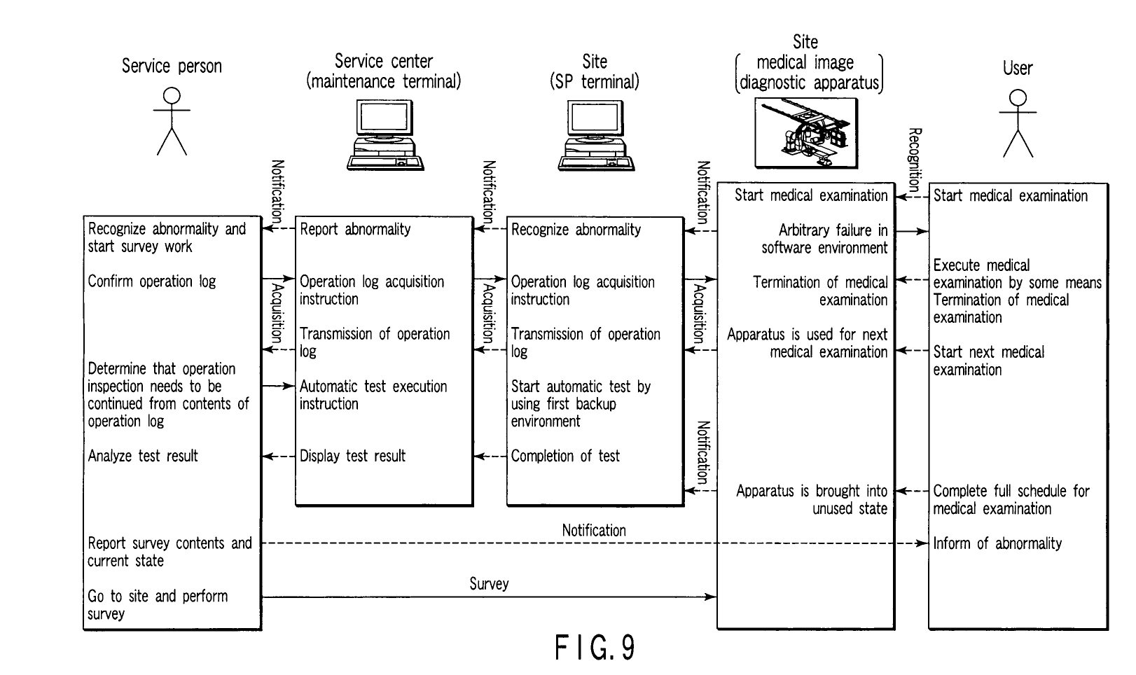

FIG. 9 is a workflow at the time of a fault preliminary survey in a software updating system according to the third embodiment.

First, while a user uses the medical image diagnostic apparatus 300 for a medical examination or the like, if a failure occurs in the control software 304, the medical image diagnostic apparatus 300 informs the user and an SP terminal 200 of the occurrence of the failure. Upon receipt of the notification, the SP terminal 200 recognizes the abnormality of the medical image diagnostic apparatus 300, and informs a maintenance terminal 100 that there is an abnormality in the medical image diagnostic apparatus 300. The maintenance terminal 100 provides an output so that a service person can confirm the abnormality by displaying a message expressing that there is an abnormality in the medical image diagnostic apparatus 300 on a display of a maintenance terminal UI 104. By confirming the displayed information, the service person recognizes that an abnormality has occurred in the medical image diagnostic apparatus 300 of the site. Further, the service person operates operation devices of the maintenance terminal UI 104 to require acquisition of an operation log from the medical image diagnostic apparatus 300. The maintenance terminal 100 transmits an instruction to acquire the operation log to the SP terminal 200. Upon receipt of the instruction, the SP terminal 200 transmits an instruction to acquire the operation log stored in a system database 305 of the medical image diagnostic apparatus 300 to the medical image diagnostic apparatus 300.

Upon receipt of the operation log acquisition instruction, the medical image diagnostic apparatus 300 acquires the operation log. After acquisition of the operation log, the medical image diagnostic apparatus 300 transmits the acquired operation log to the maintenance terminal 100 through the SP terminal 200. The maintenance terminal provides an output so that the service person can confirm the operation log by displaying the received operation log on the display of the maintenance terminal UI 104.

The service person confirms the operation log, and determines whether or not the control software 304 needs to be restored. When the control software 304 needs to be restored, in order to first perform an automatic test on the backup environment of the SP terminal 200, the service person operates the operation devices of the maintenance terminal UI 104 to start the automatic test.

When the automatic test start instruction is issued through the operation devices of the maintenance terminal UI 104, the maintenance terminal 100 requires the SP terminal 200 to perform the automatic test. At this time, a test script for performing an overall operation test is also transmitted from the maintenance terminal 100 to the SP terminal 200. Incidentally, the test script for the overall operation test may be stored in advance in a test execution script database 206 of the SP terminal 200.

Upon receipt of the automatic test start instruction from the maintenance terminal 100, the SP terminal 200 starts test execution software 203 to control each piece of control dummy software and perform a test. Further, the SP terminal 200 returns a test result to the maintenance terminal 100 each time a test item is completed. Further, when all the test items are completed, the SP terminal 200 informs the maintenance terminal 100 of the completion of all the test items. The maintenance terminal 100 updates the display of the maintenance terminal UI 104, and outputs the test result so that the service person can confirm the test result each time it receives a test result from the SP terminal 200. As described above, the test is performed on the SP terminal 200, and hence the user can use the medical image diagnostic apparatus 300 even during a medical examination.

Then, the service person confirms the test result, and reports the test result to the user. Further, if necessary, the service person goes to the site where an abnormality has occurred at the point of time at which the medical image diagnostic apparatus 300 has become out of use, and performs an additional test.

As described above, according to the third embodiment, by preliminarily surveying the abnormality of the medical image diagnostic apparatus 300, it is possible to reduce the amount of processing to be subsequently performed at the time of the restoration work.

It may be tested on an SP terminal 200 of another site whether or not a similar failure occurs in a site other than the site in which an abnormality has actually occurred on the basis of the result obtained by the abnormality preliminary survey of the third embodiment.

Incidentally, in each of the embodiments described above, a description is given of an example in which the medical image diagnostic apparatus 300 is an X-ray diagnostic apparatus. However, each of the above-mentioned embodiments can also be applied to other medical image diagnostic apparatuses such as an MRI apparatus and the like. However, the software configurations of the first and second backup environment databases 208 and 209, the configuration of the test execution software 203, and the like need to be changed in accordance with the types of the medical image diagnostic apparatuses.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A software updating apparatus which is connected to a medical image diagnostic apparatus so that the software updating apparatus freely communicates with the medical image diagnostic apparatus, and is used for updating control software for controlling an operation of the medical image diagnostic apparatus, the apparatus comprising:
a first storage section which stores software having the same configuration as the configuration of the control software;
an updating section which updates the software stored in the first storage section; and
a testing section which hypothetically tests whether or not the medical image diagnostic apparatus normally operates on the basis of the updated software.

2. The software updating apparatus according to claim 1, further comprising a transmitting section which transmits the updated software to the medical image diagnostic apparatus, and updates the control software of the medical image diagnostic apparatus if that the medical image diagnostic apparatus operates normally is determined as a result of the test.

3. The software updating apparatus according to claim 1, further comprising a determination section which determines whether or not the medical image diagnostic apparatus is in use, wherein
the transmitting section transmits the updated software to the medical image diagnostic apparatus only if the medical image diagnostic apparatus is not in use.

4. The software updating apparatus according to claim 1, further comprising a second storage section which stores software having the same configuration as the configuration of the software stored in the first storage section, wherein
after the software stored in the first storage section is updated, if that the medical image diagnostic apparatus normally operates is determined as a result of the test performed by the testing section, the updating section updates the software stored in the second storage section, otherwise the updating section updates the updated software stored in the first storage section by using the software stored in the second storage section.

5. A software updating system comprising:
a medical image diagnostic apparatus an operation of which is controlled by control software;
a first terminal device in which update software for updating the control software is stored;
a second terminal device including:
(a) a storage section which stores software having the same configuration as the configuration of the control software;
(b) an updating section which updates the software stored in the storage section by using the update software; and
(c) a testing section which hypothetically tests whether or not the medical image diagnostic apparatus operates normally on the basis of the updated software.
